(19) United States
(12) Patent Application Publication
(10) Pub. No.: US 2024/0402338 A1
(43) Pub. Date: Dec. 5, 2024

(54) COHERENT LIDAR SYSTEM FOR CAPTURING THE SURROUNDINGS WITH PHASE MODULATION FROM TWO PERIODICALLY INTERLEAVED SEQUENCES

(71) Applicant: Continental Autonomous Mobility Germany GmbH, Ingolstadt (DE)

(72) Inventor: Markus Wintermantel, Lindau (DE)

(73) Assignee: Continental Autonomous Mobility Germany GmbH, Ingolstadt (DE)

(21) Appl. No.: 18/412,196

(22) Filed: Jan. 12, 2024

(30) Foreign Application Priority Data
Jan. 13, 2023 (DE) 10 2023 200 261.

(51) Int. Cl. G01S 17/32; G01S 7/481; G01S 7/4911; G01S 7/4913; G01S 7/4915; G01S 17/931

(52) U.S. Cl. CPC G01S 17/32; G01S 7/4817; G01S 7/4911; G01S 7/4913; G01S 7/4915; G01S 17/931

(57) ABSTRACT

A coherently working lidar system for capturing the surroundings, which emits a phase-modulated signal, wherein the phase of said signal is produced by switching between discrete values from a sequence of phase values, and the times of the phase switching form a subset of an equidistant time raster. The system receives the signals reflected back from objects and converts the signals into a low-frequency signal by mixing and digitizing them in a receive sequence. The system determines the time shift and frequency shift of signals reflected by objects from said receive sequence. The phase modulation sequence includes two periodically interleaved sequences, wherein the first sequence has constant or periodic phase values and primarily serves to determine the frequency shift, whilst the second sequence substantially changes irregularly between phase values and serves to determine the time shift.

### CROSS-REFERENCE TO RELATED APPLICATIONS

This application claims priority to German patent application No. 10 2023 200 261.2, filed Jan. 13, 2023, which is incorporated by reference.

### TECHNICAL FIELD

The technical field relates generally to a coherently working lidar system, and particularly to a coherently working lidar system for capturing the surroundings for motor vehicle applications.

### BACKGROUND

Motor vehicles are increasingly being equipped with driver assistance systems which capture the surroundings with the aid of sensor systems and deduce automatic reactions of the vehicle and/or instruct, in particular warn, the driver as a result of the traffic situation recognized therefrom. A distinction is made between comfort and safety functions.

In the meantime, however, developments are going in an even more far-reaching direction. The driver is no longer only assisted, but rather the driver's task is increasingly being carried out autonomously by the vehicle, i.e., the driver is being increasingly replaced; this is referred to as autonomous driving.

In particular, autonomous driving requires sensors with highly accurate information about the surroundings, which is easy to evaluate by machines. Radar systems are limited in their angular accuracy and separation capability and cannot satisfactorily meet these high capturing requirements on their own or even in combination with camera systems, at least not yet. For this reason, lidar systems, which have a similarly high angular resolution (horizontally and vertically) to a camera, but which additionally supply distance information and separation capability in each pixel, are also deployed in parallel. Today, so-called time-of-flight lidar systems which deal with electromagnetic radiation in the sense of particles and which can, thus, only measure the distance, but not the relative speed directly, are mostly deployed. However, the focus is now also increasingly on coherently working lidar systems which deal with electromagnetic radiation in the sense of waves (like radar systems) and, therefore, can also directly measure the relative speed of objects via the Doppler effect. Further advantages of coherent lidar systems are that they are, on the one hand, robust to extraneous radiation from other sources (e.g., due to other lidar systems or sunlight) and that, on the other hand, they have a higher sensitivity at higher distances and, therefore, allow higher ranges. In addition, coherent lidar systems are credited with a higher potential for high semiconductor integration, which promises lower manufacturing costs.

In the case of coherent lidar systems, the emitted electromagnetic wave is modulated, i.e., it changes in at least one of the parameters of amplitude, frequency or phase over time—otherwise no distance measurement would be possible. The most commonly used modulation in coherent lidar systems is the linear frequency modulation (FMCW=frequency modulated continuous wave), which mostly consists of two frequency ramps, the slopes of which have opposite algebraic signs. However, said modulation does have ambiguity problems in particular in the case of multiple reflections in the same beam direction and, in addition, the production of a highly linear frequency change is elaborate. Said disadvantages do not occur or occur less in the case of a phase modulation (e.g., with pseudo-random change over discrete phase values); however, the digital evaluation of the received signals is more elaborate and the approaches proposed in the prior art are associated with disadvantages, in particular in terms of sensitivity and, therefore, range.

As such, there remains an opportunity to provide a coherent lidar system with phase modulation, which at least comes close to the maximum possible detection sensitivity, accuracy and separation capability, without requiring too high a digital computational expenditure.

### SUMMARY

The core idea is that the phase modulation sequence includes two periodically interleaved sequences, wherein the one sequence primarily serves to determine the relative speed of objects and the other sequence serves to determine their distance.

Advantages result from the fact that a lidar system having a high performance and a low price can be realized.

In one embodiment, a coherently working lidar system for capturing the surroundings, a phase-modulated signal is emitted, wherein the phase of said signal is produced by switching between discrete values, that is to say from a sequence of phase values, and the times of said phase switching form a subset of an equidistant time raster. Furthermore, the signals reflected back from objects, which are delayed with respect to the emitted signal by the distance-dependent transit time and are shifted in frequency by the relative speed-dependent Doppler effect, are received and are converted into a low-frequency signal by mixing and digitized in a receive sequence, wherein the variable dimensions time shift and frequency shift of signals reflected by objects are determined from said receive sequence in digital signal processing means. The phase modulation sequence includes two periodically interleaved sequences, wherein the first sequence has constant or periodic phase values and primarily serves to determine the frequency shift, whilst the second sequence substantially changes irregularly between phase values and serves to determine the time shift.

According to a preferred embodiment of the coherently working lidar system, the first sequence can alternate between two phase values which differ by approximately 180°.

Furthermore, the second sequence can either change pseudo-randomly between discrete phase values or consist of a code, the autocorrelated part of which has small side lobes.

A binary phase modulation, that is to say consisting of only two phase values which differ by approximately 180°, is preferably utilized.

The two sequences can expediently be alternatingly interleaved sequences, i.e., with period two based on the modulation rate.

According to a particular variant of a configuration, a phase modulation sequence consisting of two periodically interleaved sequences can also be periodically repeated, wherein in particular during a continual scanning of the laser beam the cyclical property of the modulation and receive sequence is exploited, and the surroundings are captured in different directions in each case.

The laser beam preferably scans continually and overlapping sections of a long, if necessary, periodic phase modulation sequence, which includes two periodically interleaved sequences, are utilized for the successive capturing directions.

Furthermore, the lidar system according to the invention can include the phase modulation sequence of two periodically interleaved sequences, wherein said interleaving has period N₁ with respect to the sampling time of the receive sequence. In order to determine the frequency shift of objects N1, a discrete Fourier transform is calculated, preferably with the aid of fast Fourier transforms, over values of the receive sequence from the periodic raster of the first sequence, if necessary interrupted by zeroes or extended by zeroes, as well as from N1−1 shifts of said raster, wherein the shift increases in each case by one raster value. In each of these N1 discrete Fourier transforms, the respective frequencies of peaks which lie above a detection threshold are determined, and the receive sequence in the periodic and correspondingly shifted raster of the second sequence is turned back in frequency regarding the respective frequencies and the respective raster shifts, wherein a correlation is determined in each case between the thus generated sequence and the second modulation sequence, and the respective time shift and, therefore, object distance are determined from values of said correlation, in particular of peaks lying above a detection threshold, as well as the respective raster shift, and the radial relative speed of the respective object is determined from the respective frequency wherein, if necessary, ambiguities in the frequency are resolved with the aid of the phase relationship between values of the discrete Fourier transforms and the correlation.

In order to determine the peaks of the discrete Fourier transforms, a first detection threshold can be expediently utilized, the complex value of the discrete Fourier transforms is added to the peaks thereof, and the respective complex value of the associated correlation is added multiple times to the peaks thereof in each case, if necessary, compensating for the possible phase shifts, and said sums are checked for a second detection threshold, wherein the first detection threshold lies at a lower height above the noise.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows the coherent lidar system with binary phase modulation.

FIG. 2 shows the progress of a pseudo-random binary phase modulation.

In FIG. 3, the real part of the low-frequency, analog receive signal and the associated sampling values for one object are depicted.

FIG. 4 shows the amount of the two-dimensional correlation of the receive sequence for two objects.

FIG. 5 shows a modulation sequence according to the prior art, which is sequentially composed of two subsequences.

In FIG. 6, a modulation sequence with two periodically interleaved subsequences is depicted.

FIG. 7 shows the two FFTs for the first modulation subsequence for the example of two objects.

FIG. 8 shows the two correlations regarding the second modulation subsequence for the example of two objects.

In FIG. 9, an alternative modulation sequence with two periodically interleaved subsequences is depicted.

### DETAILED DESCRIPTION

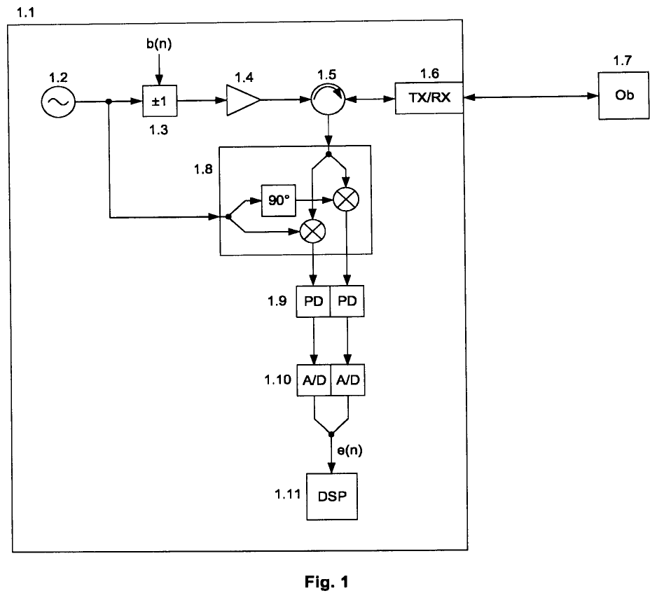

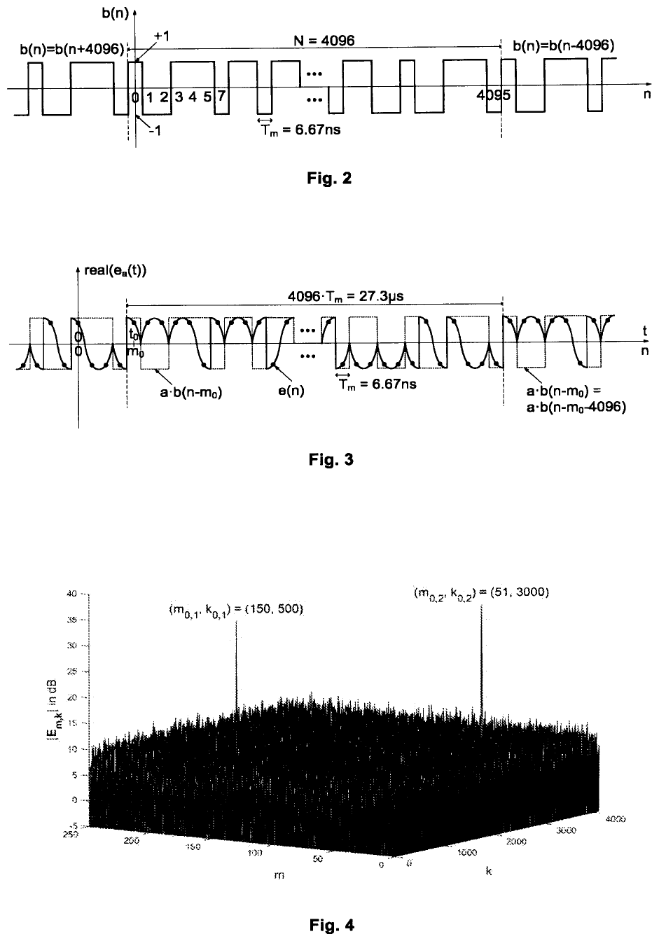

FIG. 1 schematically shows a coherent lidar system 1.1. A coherent signal in the wavelength range of approximately λ=1550 nm is produced with the laser source 1.2; the coherence length is at least multiple microseconds and the frequency is constant. Subsequently, the signal enters a switchable inverter 1.3, with which the algebraic sign of the signal can be altered, which corresponds to a phase shift of 180°. Changes in algebraic sign only take place in a fixed raster of, e.g., 6.67 ns and are pseudo-random according to a prior art, i.e., the algebraic sign is only altered with a rate or probability of 50% after Tₘ=6.67 ns. In FIG. 2, a progress of said modulation sequence b(n), which consists of the values +1 and −1 and is also referred to as binary, is depicted; it is repeated with the period N=4096, that is to say every 27.3 μs. The modulated signal passes through an amplifier 1.4, a circulator 1.5 (that is to say, a transceiver switch), is radiated via a transceiver unit 1.6 and partially reflected back from an object 1.7; with a delay which is dependent on the object distance d and, therefore, variable

$${t}_{0} = 2 d / c , \qquad ( 1 a )$$

wherein c=3·10⁸ m/s is the speed of light, and with a frequency shift which is dependent on the radial relative speed v and, therefore, variable, which is produced by the Doppler effect

$${f}_{D} = 2 v / λ \qquad ( 1 b )$$

said signal is then acquired by the transceiver unit 1.6 and is routed via the circulator 1.5 into the further receive path. In a complex-valued mixer 1.8, the modulated received signal is superimposed with the unmodulated laser signal and is converted with the aid of the photodiode unit 1.9 into a complex-valued, low-frequency signal; the frequency of said signal corresponds to the Doppler shift, the modulation of said signal is delayed by the signal transit time with respect to that of the transmit signal. In FIG. 3, the real part of said low-frequency, analog receive signal eₐ(t) is depicted in the case of one object. Subsequently, the signal is sampled and digitized in an analog-to-digital convertor unit 1.10 with the sampling frequency fₛ=150 MHz, i.e., every Tₛ=6.67 ns—the resulting values of the real part are characterized in FIG. 3 as points. The complex-valued sampling signal e(n), also referred to hereinafter as the receive sequence, can be described as follows:

$$e ( n ) = a \cdot b ( n - {m}_{0} ) \cdot exp ( 2 π \hat{j} \cdot n / N \cdot {k}_{0} ) , \qquad ( 2 a )$$

wherein it is assumed here that the transit time t₀ is an integral multiple m₀ of the modulation time Tₘ=6.67 ns:

$${m}_{0} = {t}_{0} / {T}_{m} \qquad ( 2 b )$$

$$and$$

$${k}_{0} = N \cdot {T}_{s} \cdot {f}_{D} \qquad ( 2 c )$$

which corresponds to the Doppler shift is likewise integral; a is the complex-valued amplitude of the receive sequence, “exp” denotes the exponential function and ĵ is the imaginary unit.

The complex-valued receive sequence e(n) according to (2) relates to an individual object without a longitudinal extent, and to an ideal receiver. In actual fact, there can be multiple and/or extended objects, and an additional noise r(n) is generated in the receiver, in particular due to thermal noise; this then produces the receive sequence

$$e ( n ) = {sum}_{i = 1 , … , 1} [ {a}_{i} \cdot b ( n - {m}_{0 , i} ) \cdot exp ( 2 π \hat{j} \cdot n / N \cdot {k}_{0 , i} ) ] + r ( n ) , \qquad ( 3 )$$

wherein “sum_{i=1, . . . , l}” constitutes the sum function over the index i=1, . . . , l of the l non-extended individual objects.

The discrete transit times m_{0,i} and the discrete Doppler shifts k_{0,i} of the l objects are to be established from the receive sequence e(n) of the period of time n=0,1, . . . , N−1. For a determination which is as accurate as possible, that is to say a separation of the signal and noise which is as good as possible and, therefore, for maximum sensitivity and range of the lidar system, so-called optimal filtering is to be applied, that is to say filtering by correlation between the receive sequence e(n) and the two-dimensional space ê_{m,k}(n) of the possible ideal amplitude-standardized receive sequences of an individual object:

$${\hat{e}}_{m , k} ( n ) = b ( n - m ) \cdot exp ( \hat{j} 2 π \cdot n / N \cdot k ) \qquad ( 4 )$$

$$with$$

$$m = 0 , … , M - 1 and k = 0 , … , N - 1 ;$$

M−1 corresponds to the largest object distance which is to be assumed or is of interest, and it is assumed for the Doppler shift k that it can assume any values. This therefore produces the two-dimensional correlation E_{m,k}:

$$\begin{matrix}{E}_{m , k} = {sum}_{n = 0 , … , N - 1} ( e ( n ) \cdot conj ( {\hat{e}}_{m , k} ( n ) ) \\ = {sum}_{n = 0 , … , N - 1} ( e ( n ) \cdot b ( n - m ) \cdot exp ( - \hat{j} 2 π \cdot n / N \cdot k ) ) , m = 0 , … , M - 1 and k = 0 , … , N - 1\end{matrix} \qquad ( 5 )$$

wherein “conj” denotes the complex-conjugate formation and the modulation sequence b(n) does not alter because of its real-valuedness. The correlation E_{m,k} has peaks (often referred to as power peaks) at the positions (m,k)=(m_{0,i},k_{0,i}) of objects; FIG. 4 shows the amount of the two-dimensional correlation for two objects of the same receive amplitude at (m_{0,1},k_{0,1})=(150, 500) and (m_{0,2},k_{0,2})=(51, 3000). In a further signal processing step, said peaks are established, and the distance of the objects is subsequently determined from their values m_{0,i} and their radial relative speed is determined from the k_{0,i}; that is to say, the distance and relative speed of multiple objects can be directly and clearly determined from a modulation sequence. This is a great advantage over the linear frequency modulation frequently used in the case of coherent lidar systems having two frequency ramps, the slopes of which have opposite algebraic signs—this can result in ambiguities even in the case of an individual object, and these are unavoidable in the case of multiple objects.

The calculation of said two-dimensional correlation and its downstream evaluation take place in the digital signal processing unit 1.11. It constitutes a high expenditure with the order of N·M·N. However, the above relationship (5) can also be considered as a discrete Fourier transform over the product e(n)·b(n−m), n=0, . . . , N−1 which is to be determined for each m=0, . . . , M−1; the discrete Fourier transform (DFT) is calculated by way of the fast Fourier transform (FFT):

$$\begin{matrix}{E}_{m , k} = F F {T}_{k} ( e ( n ) \cdot b ( n - m ) ) & where m = 0 , … , M - 1 ,\end{matrix} \qquad ( 6 )$$

wherein k=0, . . . , N−1 is the initial dimension of the FFT, that is to say the discrete frequency, so that the computational expenditure is reduced to the order of M·N·log₂(N).

The previously considered receive sequence e(n) of the period of time n=0,1, . . . , N−1 and the associated correlation E_{m,k} refer to an individual capturing direction, that is to say based on the horizontal and vertical direction, to one pixel. In actual fact, approximately 160,000 capturing directions, that is to say pixels, are covered in each capturing cycle of 50 ms; this is typically realized by a combination of parallel transmitter and receiver, that is to say parallel capturing of pixels, and scanning, that is to say sequential capturing of pixels. A parallel transmitter and receiver means that all of the elements 1.4-1.10 in FIG. 1 exist several times, e.g., 64 times. The scanning can happen, e.g., thanks to sequential switching or thanks to continual mechanical movement (e.g., of a mirror); during continual scanning; it is also possible that pixels partially overlap, that is to say that the back ones of the N values of the receive sequence e(n) of a pixel are also utilized as front values of the next pixel. If it is now assumed that M=250 (corresponding to the maximum distance of 249 m in the case of the above interpretation), then the FFT of length 4096 from relationship (6) is to be calculated 800 million times per second. It is not possible to realize this many FFT calculations by way of microprocessors or DSPs (Digital Signal Processors); the clock frequency of such processors is typically in the range of 1 GHz, i.e., almost one complete FFT of the length 4096 would have to be calculated per clock frequency, but modern processors can, as a general rule, only carry out up to the order of 100 multiplications and additions per clock frequency, even when using parallel vectorial computing units, which is several orders of magnitude below the requirement for an FFT of the length 4096. For this reason, it is only possible to implement this many FFTs by way of special computational logic implemented in hardware; however, said computational logic is, in general, associated with a large implementation expenditure (large chip surface) and high electrical power consumption.

In the article “Phase-Coded-Based Modulation for Coherent Lidar” by Sebastian Banzhaf and Christian Waldschmidt, published in IEEE Transactions on Vehicular Technology, vol. 70, No. 10, October 2021, an approach is proposed which manages with less computational expenditure. To this end, the binary modulation sequence b(n) of length N is composed of two parts: during the first subsequence b₁(n) with length N₁, the phase is constant, that is to say, e.g.,

$$\begin{matrix}{b}_{1} ( n ) = 1 & where n = 0 , … , {N}_{1} - 1\end{matrix} , \qquad ( 7 a )$$

and the second subsequence b₂(n) of length N₂=N−N₁ is irregular, e.g., pseudo-random:

$$\begin{matrix}{b}_{2} ( n ) = \pm 1 & where n = {N}_{1} , … , N - 1\end{matrix} . \qquad ( 7 b )$$

The lengths N₁ and N₂ can be the same, that is to say

$${N}_{2} = {N}_{1} = N / 2 , \qquad ( 7 c )$$

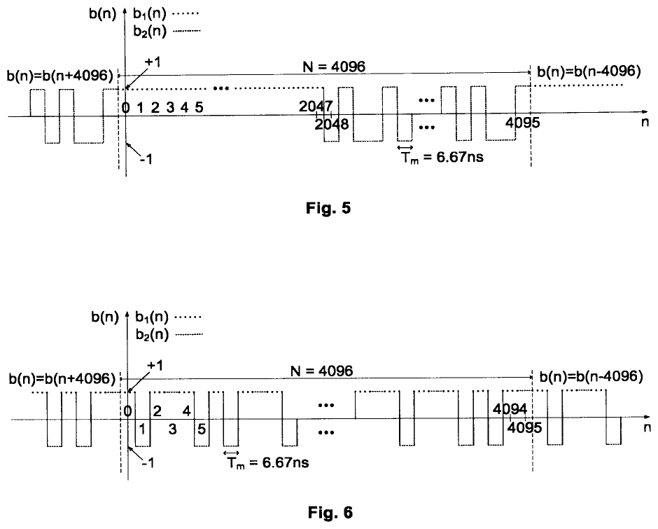

and the modulation sequence can repeat periodically for multiple capturing directions, that is to say pixels; such a modulation sequence is depicted in FIG. 5, wherein the sequence composed of the subsequences is repeated with period N=4096.

The following applies to the receive subsequence e_{1,i}(n) generated by an object i regarding the first, constant modulation subsequence b₁(n) according to relationship (2a):

$$\begin{matrix}{e}_{1 , i} ( n ) = {a}_{i} \cdot exp ( 2 π \hat{j} \cdot n / N \cdot {k}_{0 , i} ) & where n = {m}_{0 , i} , … , {m}_{0 , i} + N / 2 - 1 ,\end{matrix} \qquad ( 8 )$$

i.e., it only carries the Doppler frequency of the respective object, which can be determined by way of a DFT or FFT. However, due to the unknown time shifts m_{0,i}, the respective exact temporal location of e_{1,i}(n) within the receive sequence e(n) is not known; the time shift can be simply assumed to be zero, for example, i.e., over the receive subsequence

$${\tilde{e}}_{1} ( n ) = e ( n ) where n = 0 , … , N / 2 - 1 \qquad ( 9 )$$

the FFT is formed

$${\tilde{E}}_{1 , k} = F F {T}_{k} ( {\tilde{e}}_{1} ( n ) ) = F F {T}_{k} ( e ( n ) ) where n = 0 , … , N / 2 - 1. \qquad ( 10 )$$

However, the result of the assumption that the time shift is zero is that there are not any values of the constant modulation subsequence b₁(n) for other actual time shifts m_{0,i}, that is to say in particular for distant destinations, in the first m_{0,i}−1 values of the receive subsequence \tilde{e}1(n), but rather back values of the modulation subsequence b₂(n) of the preceding period; therefore, the height of the respective peak of the FFT, and therefore, its distance from the noise is reduced so that the sensitivity is reduced. The peaks of the FFT \tilde{E}_{1,k} of the receive subsequence \tilde{e}₁(n) are checked for a detection threshold. The frequencies k_{0,j} of the J peaks lying above the detection threshold are utilized for the further processing; typically, these peaks are seen in two adjacent FFT values (since they do not lie—as previously considered—at an integral Doppler index k₀), so that their exact location, that is to say a non-integral frequency k_{0,j}, can then be determined by interpolation. Said frequencies k_{0,j} correspond at least approximately to the Doppler frequencies k_{0,i} of the objects or a subset of these (for objects with very low reflectivity, it can be that they do not result in a peak above the detection threshold).

According to relationship (2a), the second modulation subsequence b₂(n) results, in the receive sequence e(n), in components which are time-shifted by m_{0,i} and multiplied by the respective Doppler frequency k_{0,i}, that is to say modulated

$${e}_{2 , i} ( n ) = {a}_{i} \cdot {b}_{2} ( n - {m}_{0 , i} ) \cdot exp ( 2 Π \hat{j} \cdot n / N \cdot {k}_{0 , i} ) \qquad ( 11 )$$

$$where$$

$$n - {m}_{0 , i} = N / 2 , … , N - 1.$$

In order to eliminate the respective modulation by the Doppler frequency, the receive sequence e(n) is, in each case, turned back by the frequency k_{0,j}:

$${\tilde{e}}_{2 , j} ( n ) = e ( n ) \cdot exp ( - 2 Π \hat{j} \cdot n / N \cdot {k}_{0 , j} ) \qquad ( 12 )$$

$$where$$

$$n = N / 2 , … , N - 1 + M - 1 and j = 1 , … J - 1 ;$$

the region n=N/2, . . . , N−1+M−1 of the receive sequence e(n) must be considered in which the reception of the second modulation subsequence b₂(n) can lie, wherein M−1 corresponds to the largest object distance which is to be assumed or is of interest. It should be noted that the region n=N, . . . , N−1+M−1 of the receive signal can only be utilized during continual scanning, however not during switched scanning (then the signal there is not coherent due to the other capturing direction).

The thus modified sequences \tilde{e}_{2,j}(n) include j shifted modulation subsequences aᵢ·b₂(n−m_{0,i}) in the corresponding index; contributions of objects having other Doppler frequencies k_{0,i} (that is to say, k_{0,i}≠k_{0,j}) constitute an uncorrelated modulation sequence for b₂(n), since they are still modulated with the difference frequency k_{0,i}−k_{0,j}. For this reason, the sequences \tilde{e}_{2,j}(n) can then be correlated with the second modulation subsequence b₂(n):

$${\tilde{E}}_{2 , j , m} = {sum}_{n = N / 2 , … , N - 1} ( {\tilde{e}}_{2 , j} ( n + m ) \cdot {b}_{2} ( n ) ) \qquad ( 13 )$$

$$where$$

$$m = 0 , … , M - 1 and j = 1 , … , J - 1.$$

In said one-dimensional correlations \tilde{E}_{2,j,m}, peaks occur at the positions m=m_{0,i}, that is to say at the discrete transit times of objects; in the general case of a non-integral discrete transit time m_{0,i}, the peak extends, during suitable measures (e.g., distorting of the modulation pulses to an approximately triangular shape), over two adjacent values of m, and its non-integral position can be established by interpolation. The Doppler frequency k_{0,i}=k_{0,j} of the object is produced from the index j of the correlation \tilde{E}_{2,j,m}, at which the peak occurs, and the Doppler frequency k_{0,j} belonging to said j. Thus, the distances and radial relative speeds of objects in the respective capturing direction can be determined from peaks of the correlations \tilde{E}_{2,j,m} lying above a detection threshold. It should be noted that contributions of objects having, in each case, other Doppler frequencies k_{0,i} (that is to say k_{0,i}≠k_{0,j}) only result in noise in the respective correlations, that is to say no peaks above a detection threshold, due to the fact that they are not correlated with b₂(n); in the case of approximately equally strong reflection signals from objects, said noise is notably below the peaks of interest and does not therefore conceal these—only when reflection signals from objects are considerably different can objects having a strong reflection signal conceal weak reflection signals having another Doppler frequency by way of their noise.

With the modulation sequence according to FIG. 5 and the evaluation explained above, in the typical case of one object in one pixel, an FFT is required for the receive subsequence e₁(n) for the first modulation subsequence b₁(n) and a correlation between the second modulation subsequence b₂(n)and the frequency turned-back receive subsequence \tilde{e}_{2,1}(n) for the second modulation subsequence. Said correlation in the time range can also be realized by multiplying the FFTs in the frequency range with a subsequent inverse FFT (an inverse FFT requires the same computational expenditure as the FFT itself); the FFT of the modulation subsequence b₂(n) can first be determined a priori, so that only the FFT of the receive subsequence \tilde{e}_{2,1}(n) has to be determined. Overall, that is to say that the expenditure of three FFTs is incurred, whereas in the case of the two-dimensional correlation E_{m,k} according to relationship (6), a total of M=250 FFTs are to be calculated, wherein said FFTs have approximately twice the length if the same duration of a pixel is assumed. This therefore results in a very strong reduction of the required computational expenditure to a magnitude which modern DSPs having parallel vectorial computing units open up.

In particular, the following points are disadvantageous, compared with a modulation sequence according to FIG. 2 and evaluation via a two-dimensional correlation E_{m,k} according to relationship (5):
The sensitivity is a little more than 3 dB lower when the same duration of a pixel is assumed; half the length of the FFT (from the receive subsequence e1(n)) as well as half the length of the temporal correlation (from \tilde{e}_{2,j}(n) for the modulation subsequence b₂(n)) results in a loss of 3 dB and in addition, as explained above, there is the effect that, in particular for distant targets, the first values of the receive subsequence \tilde{e}₁(n) do not originate from the constant modulation subsequence b₁(n), but rather from back values of the modulation subsequence b₂(n) of the preceding period, so that said values do not effectively contribute to the respective peak of the FFT.
Due to half the length of the FFT, the resolution and accuracy for the Doppler determination, i.e., the determination of the radial relative speed, are worse by a factor of two.
The temporal correlation of \tilde{e}_{2,j}(n) with b2(n) for determining the distance only has half the length. Therefore, the dynamic range is reduced by 3 dB per pixel in the case of more than one object, i.e., an object having a strong reflection signal increases the noise level relative to the level of an object with weaker reflection signal by 3 dB more, so that the probability of the non-detection of such a second object is higher.
In the case of continually scanning systems, pixels can generally be made to overlap, i.e., some of the receive values e(n) are utilized for two adjacent pixels, in particular in order to attain a longer data acquisition time per pixel and, therefore, a better sensitivity. In the case of a modulation sequence according to FIG. 5, however, there is only the possibility of an overlap of 50%, since both modulation subsequences are required in each pixel. Smaller overlaps, which are frequently preferred, are not possible.

Said disadvantages of the modulation sequence according to FIG. 5 and of the associated evaluation explained above, which are the prior art, can be remedied to a significant extent by the modulation sequence according to the invention and shown in FIG. 6, without the computing power required for the evaluation significantly increasing. In the case of the modulation sequence b(n) according to FIG. 6, the two previous modulation subsequences b₁(n) and b₂(n) are interleaved in an alternating manner:

$$\begin{matrix}{b}_{1} ( n ) = 1 & where n = 0 , 2 , 4 , … , N - 2 ,\end{matrix} \qquad ( 14 a )$$

$$\begin{matrix}{b}_{2} ( n ) = \pm 1 & where n = 1 , 3 , 5 , … , N - 1.\end{matrix} \qquad ( 14 b )$$

Consequently, both modulation subsequences extend, in each case, over the full modulation duration, wherein they only take up every second raster value in each case.

The receive subsequence e_{1,i}(n) generated by an object i regarding the first, constant modulation subsequence b₁(n) can either be even or odd values of n, depending on whether the discrete transit time m_{0,i} of the respective object is even or odd (here it is first assumed that m_{0,i} is an integer):

$${e}_{1 , i} ( n ) = {a}_{i} \cdot exp ( 2 Π \hat{j} \cdot n / N \cdot {k}_{0 , i} ) \qquad ( 15 )$$

$$where$$

$$n = 0 , 2 , 4 , … , N - 2 or n = 1 , 3 , 5 , … N - 1 ;$$

in the case of this range of the index n, the first values originate from the end of the previous modulation period (due to the transit time of the respective object)—in contrast to the previously considered modulation sequence according to FIG. 5, said values, however, also come from the first, constant modulation sequence, so that they also contribute coherently to the later FFT. Due to the two possible locations of the receive subsequences e_{1,i}(n), the FFT has to now be calculated twice in order to determine the Doppler frequencies of the objects—once over the first sequence

$${\tilde{e}}_{1 , 1} ( n ) = e ( n ) where n = 0 , 2 , 4 , … , N - 2 , \qquad ( 16 a )$$

and once over the second sequence

$${\tilde{e}}_{1 , 2} ( n ) = e ( n ) where n = 1 , 3 , 5 , … , N - 1. \qquad ( 16 b )$$

The two FFTs

$${\tilde{E}}_{1 , 1 \underline{k}} = F F {T}_{\underline{k}} ( {\tilde{e}}_{1 , 1} ( n ) ) = F F {T}_{\underline{k}} ( e ( n ) ) where n = 0 , 2 , 4 , … , N - 2 , \qquad ( 17 a )$$

$${\tilde{E}}_{1 , 2 \underline{k}} = F F {T}_{\underline{k}} ( {\tilde{e}}_{1 , 2} ( n ) ) = F F {T}_{\underline{k}} ( e ( n ) ) where n = 1 , 3 , 5 , … , N - 1 \qquad ( 17 b )$$

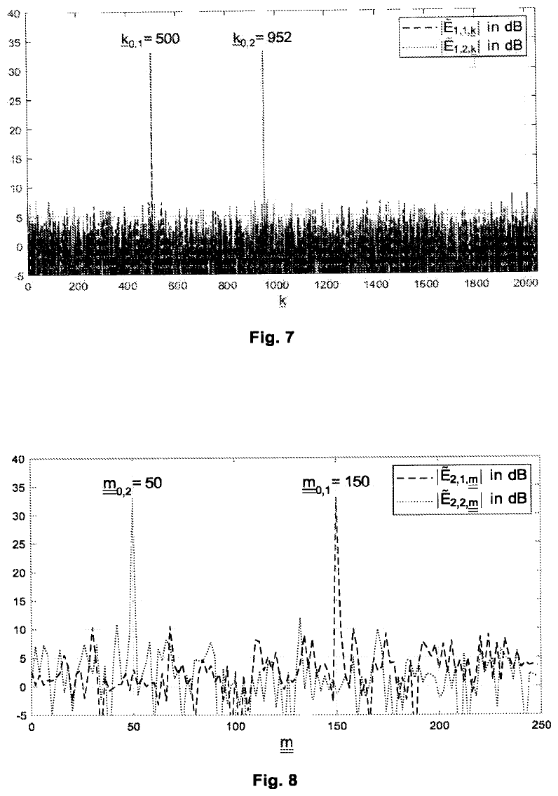

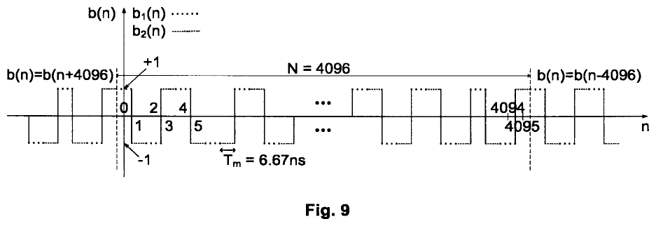

refer to the initial dimension, that is to say the discrete frequency k=0, . . . , N/2−1, which is related to the previously considered discrete frequency k due to the effective half sampling rate over

$$\underline{k} = mod ( k , N / 2 ) \qquad ( 18 )$$

wherein “mod(⋅,N)” constitutes the modulo function regarding module N. In FIG. 7, the two FFTs are depicted according to relationship (17), according to amount, for two objects of the same receive amplitude at (m_{0,1},k_{0,1})=(150, 500) and (m_{0,2},k_{0,2})=(51, 3000); the first object during the even discrete transit time m_{0,1}=150 forms a peak in the first FFT \tilde{E}_{1,1,k} in the Doppler frequency k_{0,1}=k_{0,1}=500, the second object during the odd discrete transit time m_{0,2}=51 forms a peak in the second FFT \tilde{E}_{1,2,k} at the Doppler frequency k_{0,2}=k_{0.2}−N/2=952.

The peaks of the two FFTs \tilde{E}_{1,1,k} and \tilde{E}_{1,2,k} are checked for a detection threshold. The frequencies k_{0,j} of the J peaks lying above the detection threshold are utilized for the further processing; typically, these peaks are seen in two adjacent FFT values (since they do not lie—as considered in the above example—at an integral Doppler index k_{0,j}), so that their exact location, that is to say a non-integral frequency k_{0,j}, can then be determined by interpolation. With the exception of a possibly missing component N/2 (due to the modulo function according to relationship (18)), said frequencies k_{0,j} correspond at least approximately to the Doppler frequencies k_{0,i} of the objects or a subset of these (for objects with very low reflectivity, it may be that they do not result in a peak above the detection threshold). For further processing, it must also be taken into account in which of the two FFTs the peak was detected at k_{0,j} that is to say whether the associated discrete transit time is even or odd; to that end, the variable

$${\underline{m}}_{i} ∈ \{ 0 , 1 \} \qquad ( 19 )$$

is introduced, wherein mⱼ=0 when the peak occurs in the first FFT \tilde{E}_{1,1,k} and mⱼ=1, when the peak occurs in the second FFT \tilde{E}_{1,2,k}.

The second modulation subsequence b₂(n) according to relationship (14b) results, in the receive sequence e(n), in components which are time-shifted by m_{0,i} and multiplied by the respective Doppler frequency k_{0,i}, that is to say modulated

$${e}_{2 , i} ( n ) = {a}_{i} \cdot {b}_{2} ( n - {m}_{0 , i} ) \cdot exp ( 2 Π \hat{j} \cdot n / N \cdot {k}_{0 , i} ) \qquad ( 20 )$$

$$where$$

$$n - {m}_{0 , i} = 1 , 3 , 5 , … , N - 1.$$

In order to eliminate the respective modulation by the Doppler frequency, the receive sequence e(n) is turned back by the frequency k_{0,j}:

$${\tilde{e}}_{2 , j} ( n ) = e ( n + {\underline{m}}_{i} ) \cdot exp ( - 2 Π \hat{j} \cdot n / N \cdot {\underline{k}}_{0 , j} ) \qquad ( 21 )$$

$$where$$

$$n = 1 , 3 , 5 , … , N - 1 and j - 1 , …J - 1 ;$$

where the quantity mⱼ introduced into relationship (19) takes into account whether the respective receive subsequence lies in an odd or even raster (that is to say, has an even or odd discrete transit time); and it should also be noted that—as during the determination of the FFT—in the case of this range of index n, the first received values originate from the end of the previous modulation period (due to the transit time of the respective object), which does not, however, violate the coherence for the following correlation due to the periodicity of the entire modulation sequence (which has period N).

The thus modified sequences \tilde{e}_{2,j}(n) include, in the corresponding index, j cyclically shifted modulation subsequences aᵢ·b₂(mod(n−m_{0,i},N)). Contributions of objects having other Doppler frequencies k_{0,i} (that is to say, k_{0,i}≠k_{0,j}) constitute an uncorrelated modulation sequence for b₂(n), as they are still modulated with the difference frequency k_{0,i}−k_{0,j}; the same applies to contributions with other mⱼ, as these are modulated with b₁(n). For this reason, the sequences \tilde{e}_{2,j}(n) can now be cyclically modulated with the second modulation subsequence b₂(n):

$${\tilde{E}}_{2 , j , {m}_{=}} = s u {m}_{n = 1 , 3 , … , N - 1} ( {\tilde{e}}_{2 , j} ( n ) \cdot {b}_{2} ( mod ( n - {m}_{=} , N ) ) ) \qquad ( 22 )$$

$$where$$

$${m}_{=} = 0 , 2 , … , M - 2 and j = 1 , …J - 1.$$

In said one-dimensional correlations \tilde{E}_{2,j,m}, peaks occur at the positions m_{0,j}=m_{0,i}−mⱼ, that is to say at the discrete transit times m_{0,i} of objects minus the shift mⱼ applied in relationship (21), so that the discrete transit time of m_{0,i}=m_{0,j}+mⱼ is obtained. For the above example with two objects, the amounts of the two correlations \tilde{E}_{2,1,m} for \tilde{e}_{2,1}(n) where k_{0,1}=150 and m₁=0 as well as \tilde{E}_{2,2,m} for \tilde{e}_{2,2}(n) where k_{0,2}=952 and m₂=1 are depicted in FIG. 8; the peaks lie at the values m_{0,1}=150 as well as m_{0,2}=50 which correspond to the discrete transit times m_{0,1}=m_{0,1}+m₁=150 as well as m_{0,2}=m_{0,2}+m₂=51.

The Doppler frequency k_{0,i} of the object is produced from the index j of the correlation \tilde{E}_{2,j,m}, at which the peak occurs, and the Doppler frequency k_{0,j} belonging to said j, only except for a potential offset of N/2—see relationship (18), which takes into account the fact that the Doppler frequency is determined from a sequence with half a sampling rate, i.e., an additional half period, based on the full sampling rate, cannot therefore be recognized. However, such a half period results in the fact that the complex values at the respective peaks in FFT \tilde{E}_{1,1,k} or \tilde{E}_{1,2,k} and correlation \tilde{E}_{2,jm} are rotated by 180° with respect to each other, whilst, in the other case (that is to say no additional half period in Doppler frequency), they have the same phase. With said relation, the ambiguity regarding the respective Doppler frequency k_{0,i} can be solved by adding the two complex values corrected by the possible phase shifts (0° and 180°), that is to say the sum and difference of the two complex values are formed—if the sum has a greater amount than the difference, then the Doppler frequency k_{0,i}=k_{0,j}, in the other case, k_{0,i}=k_{0,j}+N/2; in the above example, for the first object (that is to say for k=k_{0,1} and m=m_{0,1}), the sum \tilde{E}_{1,1,k}+\tilde{E}_{2,1,m} is greater than the difference \tilde{E}_{1,1,k}−\tilde{E}_{2,1,m} (due to the fact that the two components are approximately in-phase), so that the Doppler frequency k_{0,1}=k_{0,1}=500, and for the second object (that is to say for k=k_{0,2} and m=m_{0,2}), the difference \tilde{E}_{1,2,k}−\tilde{E}_{2,2,m} is greater than the sum \tilde{E}_{1,2,k}+\tilde{E}_{2,2,m} (due to the fact that the two components are approximately antiphase), so that the Doppler frequency k_{0,2}=k_{0,2}+N/2=3000. The fact that the Doppler frequency is now determined over the full duration of a modulation period means there is no longer the disadvantage of the modulation sequence according to FIG. 5 (according to the prior art), where the resolution and accuracy are reduced for the Doppler determination by a factor of two, since the FFT is only determined over half the modulation duration.

The distances and radial relative speeds of objects in the respective capturing direction can be determined with the relations and procedures depicted above from the peaks of the correlations \tilde{E}_{2,j,m} lying above a detection threshold. It should be noted that contributions of objects having, in each case, other Doppler frequencies k_{0,i} (that is to say, k_{0,i}≠k_{0,j}) and/or other value mⱼ only result in noise in the respective correlations, that is to say no peaks above a detection threshold, due to the fact that they are not correlated with b₂(n); in the case of approximately equally strong reflection signals from objects, said noise is notably below the peaks of interest and does not therefore conceal these—only when reflection signals from objects are considerably different can objects having a strong reflection signal conceal weak reflection signals having another Doppler frequency by way of their noise.

As an alternative to the approach that detections are generated from peaks of the correlations \tilde{E}_{2,j,m} lying above a detection threshold, the sums and differences of FFT \tilde{E}_{1,1,k} or \tilde{E}_{1,2,k} where k=k_{0,j} and correlation \tilde{E}_{2,j,m} introduced above can be checked for a detection threshold, since that value of the sum and difference, in which the two components FFT and correlation are phase-correct, i.e., coherent, are added, has a signal-to-noise ratio which is 3 dB better than the correlation itself; this is due to the fact that, in the case of the sum or difference, integration is effected over the whole modulation sequence b(n), but in the case of the correlation only over half. The sum or difference therefore also has the same signal-to-noise ratio and, therefore, the same sensitivity as the optimal two-dimensional correlation E_{m,k} according to relationship (5). However, this only applies if a peak has already been detected in the FFT at the corresponding position in each case, that is to say at k=k_{0,j}; since the FFT has a signal-to-noise ratio which is 3 dB worse due to half the integration time; a correspondingly reduced detection threshold has to be applied. Said reduced detection threshold has an increased probability that noise peaks are wrongly detected; however, these are then discarded again at the effectively sharper detection threshold of sum and difference of FFT and correlation, so that the only disadvantage remains a slightly increased computational expenditure (because correlation \tilde{E}_{2,j,m} has to be calculated quite often). It should also be noted that the sum and difference do not have to be determined for each m, but rather that the correlation \tilde{E}_{2,j,m} can also be first of all checked for a detection threshold which is reduced by approximately 3 dB and only at those positions where said detection threshold is exceeded are the sum and difference. The fact that the approach according to the invention of the modulation sequence according to FIG. 6 and the evaluation described above has the same sensitivity as the optimal two-dimensional correlation E_{m,k} according to relationship (5) means that the disadvantage of the modulation sequence according to FIG. 5 (prior art) of a 3 dB worse sensitivity is remedied. It will now be briefly discussed whether the approach according to the invention of the sum and difference of FFT and correlation could not also be applied in the case of the modulation sequence according to FIG. 5: This is only possible if the receive phase is linear, in a stable manner, over the whole modulation sequence (that is to say, instantaneous frequency is constant), which only exists, to a limited extent, in particular due to speckle effects.

The sum and difference of the FFT and correlation approach also avoids the disadvantage of the modulation sequence according to FIG. 5 (prior art) of a dynamic range reduced by 3 dB when there is more than one object per pixel, because integration now takes place over the full modulation sequence.

A further advantage of the modulation sequence according to the invention and shown in FIG. 6 is that any overlaps can be realized for two adjacent pixels, since each section of said periodic modulation sequence (period N) has the characteristic property according to relationship (14).

The computational expenditure required for the approach according to the invention with the modulation sequence according to FIG. 6 differs from that for the modulation sequence according to FIG. 5 (prior art) due to an additional FFT of length N/2 (independent of the number of objects in the respective pixel), whereas the correlations only have half the length, which does not however constitute an advantage during the realization of the correlation in the frequency range (that is to say, via FFT and inverse FFT). In the typical case of one object in one pixel, two FFTs and a correlation are to be determined. In the case of the approach explained above having a reduced detection threshold for the FFTs, additional calculations of the correlation can occur in principle. Therefore, the required computational expenditure is still within an order of magnitude which modern DSPs having parallel vectorial computing units can open up, which results in a low-cost realization.

For the initial dimension of the FFT, that is to say the discrete frequency, the non-symmetrical range k=0, . . . , N/2−1 was considered above, as is generally the case—as well as for the discrete frequency after resolving the ambiguities, the non-symmetrical range k=0, . . . N−1; the actual relative speeds and, therefore, Doppler frequencies can assume both algebraic signs, so that the upper range, e.g., the upper half of k=0, . . . N−1, is to be depicted for negative values by subtracting N.

As an alternative to the previously considered modulation sequence according to the invention and shown in FIG. 6, alternating values (that is to say, in alternating fashion, +1 and −1) can be utilized for the modulation subsequence b1(n)—this is depicted in FIG. 9. The only material difference is that the receive subsequences regarding said b₁(n) have an additional frequency with period two (based on the modulation rate of b₁(n)), that is to say the peaks of the two associated FFTs \tilde{E}_{1,1,k} and \tilde{E}_{1,2,k} are shifted by half a FFT length N/4, which is to be corrected accordingly for the further processing.

So far, the case has been considered that the discrete transit time m_{0,i} is integral and the modulation time Tₘ is equal to the sampling repetition time Tₛ. For a non-integral discrete transit time m_{0,i}, it could happen in the case of an ideal rectangular modulation signal, which retains its ideal shape even in the receive signal, that it is sampled exactly at the edge where no meaningful information can be obtained. In order to avoid this, either the sampling repetition time Tₛ of the receive sequence can be provided so that it is smaller, e.g., half the size of the modulation duration Tₘ, or the form of the modulation pulse is either directly distorted, e.g., to an approximately triangular shape, when it is generated or in the receiver. In the case of the approach with distortion of the modulation signal and the general case of a non-integral discrete transit time m_{0,i}, peaks occur in both FFTs \tilde{E}_{1,1,k} and \tilde{E}_{1,2,k} so that the correlation \tilde{E}_{2,j,m} for both mⱼ=0,1 can be determined and, by interpolation of the values of the peaks of both correlations, the non-integral m_{0,i} can be established (the non-integral m_{0,i} could also be determined by interpolation of the values of the peaks of the two FFTs or by combination, that is to say the sum or difference of the values of FFT and correlation). In the case of the approach of, e.g., half as large a sampling time Tₛ (compared with the modulation time Tₘ), the interleaving of the two modulation subsequences with respect to the sampling time has the period 4 and, in the receive signal, two consecutive sampling values originate in each case from the first sequence b₁(n) and the next two sampling values originate from the second sequence b₂(n); for this reason, on the one hand, four possible locations are to be taken into account for the receive subsequences e_{1,i}(n), that is to say four FFTs \tilde{E}_{1,1,k}, . . . , \tilde{E}_{1,4,k} are to be calculated and, on the other hand, the sampling values corresponding to b₂(n) are to be set to zero (because they are no longer in the raster of period 2 and can, consequently, be simply omitted), so that the FFT is to be calculated over the full number of receive values (as opposed to half the number so far). In at least a part of said FFTs, three peaks of an individual object then occur; the largest at the correct position, that is to say the Doppler frequency of the object (in contrast to the above, there are no more ambiguities, which is advantageous), and two further peaks which are smaller by 3 dB, a quarter of the FFT length before and thereafter (these are to be ignored for the further processing). As peaks occur in multiple of the four FFTs \tilde{E}_{1,1,k}, . . . , \tilde{E}_{1,4,k}, a nonintegral discrete transit time can be established by interpolation (using the values of the FFTs or the correlations or their combinations).

In addition to the case considered so far that the two modulation subsequences b₁(n) and b₂(n) are interleaved, in an alternating manner, that is to say with period two, longer periods for the interleaving as well as optionally still an unequal number of elements of b₁(n) and b₂(n) can in principle be used per period.

In the lidar system considered so far according to FIG. 1, the mixer has a complex-valued design, which constitutes a notable additional expenditure (virtually double) with respect to a real-valued mixer for the receive path. When using a real-valued mixer, only the amount of the relative speed could be established, not the algebraic sign, since there are two peaks at+k₀ and−k₀ in the FFTs. To establish the algebraic sign, approaches via plausibility checking and/or tracking, i.e., pursuing over multiple acquisition cycles would be necessary. Alternatively, a complex-valued modulation sequence, e.g., consisting of the four values +1, −1, +j and −j, can be used. For the first modulation subsequence b₁(n), rotation then takes place periodically over the four values +1, +j, −1, −j, so that in the case of an object having the relative speed zero, the peak lies at a quarter of the FFT length—negative relative speeds lie therebelow (that is to say, they have a lower frequency), positive ones lie thereabove. Said first modulation subsequence b₁(n) which has, in turn, a period 4, is furthermore interleaved, in an alternating manner, with the second modulation subsequence b₂(n), which can also assume said four values +1, −1, +j and −j, e.g., in a pseudo-random sequence. It is true that the production of such a complex-valued sequence does require an increased circuit complexity, but this is only needed once, whereas the expenditure for a complex-valued receiver is incurred multiple times in the case of a parallel receiver. In the case of a complex-valued modulation sequence, the conjugated complex of the modulation sequence is to be utilized for the correlation. Alternatively, the conjugated complex of the receive sequence can also be utilized, provided that this is complex-valued.

So far, the case has been considered that no window function is utilized for the FFT, that is to say no multiplication of the input values of the FFT by a kind of bell curve; this would only be necessary or useful if two objects having a similar relative speed and notably different reflectivity can occur at the same distance in one pixel and are to be separated. In particular, when no window function is utilized at the input of the FFT, the sensitivity at the output of the FFT is then reduced (that is to say, the detection capacity of objects having a weak reflectivity and high distance), when the Doppler index corresponding to the relative speed is not integral, that is to say the peak is divided between two adjacent FFT values. Said effect can be reduced by selecting the length of the FFT to be higher than that of its input signal, i.e., zeros are appended to the input signal, which is referred to as zero padding.

With regard to the second modulation subsequence b₂(n), it should be noted that it cannot only be formed from a pseudo-random change between discrete phase values, but also from a code, the autocorrelated part of which has small side lobes—e.g., from a gold code known in the literature. This results in a higher dynamic range of the correlation, however only when there are no signal components (e.g., from objects of another relative speed) which constitute noise in the signal to be correlated.

1. A coherently working lidar system for capturing the surroundings, which
emits a phase-modulated signal, wherein the phase of said signal is produced by switching between discrete values, that is to say from a sequence of phase values, and the times of said phase switching form a subset of an equidistant time raster,
receives the signals reflected back from objects, which are delayed with respect to the emitted signal by the distance-dependent transit time and are shifted in frequency by the relative speed-dependent Doppler effect, and converts said signals into a low-frequency signal by mixing and digitizes them in a receive sequence, and
determines the variable dimensions time shift and frequency shift of signals reflected by objects from said receive sequence in digital signal processing means, and
the phase modulation sequence includes two periodically interleaved sequences, wherein the first sequence has constant or periodic phase values and primarily serves to determine the frequency shift, whilst the second sequence substantially changes irregularly between phase values and serves to determine the time shift.

2. The lidar system according to claim 1, in which the first sequence alternates between two phase values which differ by approximately 180°.

3. The lidar system according to claim 1, in which the second sequence either changes pseudo-randomly between discrete phase values or consists of a code, the autocorrelated part of which has small side lobes.

4. The lidar system according to claim 1, in which a binary phase modulation, that is to say consisting of only two phase values which differ by approximately 180°, is utilized.

5. The lidar system according to claim 1, in which the two sequences are alternatingly interleaved sequences, i.e., with period two based on the modulation rate.

6. The lidar system according to claim 1, in which a phase modulation sequence consisting of two periodically interleaved sequences is periodically repeated, wherein in particular during a continual scanning of the laser beam the cyclical property of the modulation and receive sequence is exploited, and the surroundings are captured in different directions in each case.

7. The lidar system according to claim 1, in which the laser beam continually scans and overlapping sections of a long, if necessary, periodic phase modulation sequence, which includes two periodically interleaved sequences, are utilized for the successive capturing directions.

8. The lidar system according to claim 1, in which
the phase modulation sequence includes two periodically interleaved sequences, wherein said interleaving has period N1 with respect to the sampling time of the receive sequence,
in order to determine the frequency shift of objects N1, discrete Fourier transforms, are calculated, preferably with the aid of fast Fourier transforms, over values of the receive sequence from the periodic raster of the first sequence, if necessary interrupted by zeroes or extended by zeroes, as well as from N1−1 shifts of said raster, wherein the shift increases in each case by one raster value,
in each of these N1 discrete Fourier transforms, the respective frequencies of peaks which lie above a detection threshold are determined,
the receive sequence in the periodic and correspondingly shifted raster of the second sequence is turned back in frequency regarding the respective frequencies and the respective raster shifts,
a correlation is determined in each case between the thus generated sequence and the second modulation sequence, and
the respective time shift and, therefore, object distance are determined from values of said correlation, in particular of peaks lying above a detection threshold, as well as the respective raster shift, and the radial relative speed of the respective object is determined from the respective frequency wherein, if necessary, ambiguities in the frequency are resolved with the aid of the phase relationship between values of the discrete Fourier transforms and the correlation.

9. The lidar system according to claim 8, in which, in order to determine the peaks of the discrete Fourier transforms, a first detection threshold is utilized, the complex value of the discrete Fourier transforms is added to the peaks thereof, and the respective complex value of the associated correlation is added multiple times to the peaks thereof, in each case, if necessary, compensating for the possible phase shifts, and said sums are checked for a second detection threshold, wherein the first detection threshold lies at a lower height above the noise.

10. A coherent lidar system for capturing surroundings of a vehicle, the system comprising:
a laser source configured to produce a coherent signal;
a switchable inverter configured to receive the coherent signal from the laser source and generate a phase-modulated signal by switching between discrete values to form a sequence of phase values, the times of the phase switching forming a subset of an equidistant time raster;
a transceiver unit configured to emit the phase-modulated signal;
said transceiver unit configured to receive signals reflected back from objects, the received signals being delayed with respect to the emitted signal by the distance-dependent transit time and are shifted in frequency by the relative speed-dependent Doppler effect;
a mixer configured to convert the received signals into a low-frequency signal by mixing and digitizing them in a receive sequence; and
a digital signal processing unit configured to determine the variable dimensions time shift and frequency shift of signals reflected by objects from the receive sequence; and
the phase modulation sequence includes two periodically interleaved sequences, wherein the first sequence has constant or periodic phase values and primarily serves to determine the frequency shift, whilst the second sequence substantially changes irregularly between phase values and serves to determine the time shift.
